(19) United States
(12) Patent Application Publication
(10) Pub. No.: US 2026/0299945 A1
(43) Pub. Date: Oct. 1, 2026

(54) SYSTEM AND METHOD FOR IMPLEMENTING QUIRES USING A MEMORY CONTROLLER

(71) Applicant: Tactical Computing Laboratories, LLC, Muenster, TX (US)

(72) Inventor: Martin M. Deneroff, New York, NY (US)

(21) Appl. No.: 19/092,952

(22) Filed: Mar. 27, 2025

(51) Int. Cl. G06F 9/30; G06F 12/0804

(52) U.S. Cl. CPC G06F 9/30025; G06F 9/3891; G06F 12/0804; G06F 13/1663; G06F 15/7821

(57) ABSTRACT

Methods for performing posit processes using a quire implemented by a memory controller and corresponding systems and computer-readable mediums. A method performed by the memory controller can include receiving one or more quire operation commands from at least one processing core, executing the quire operation commands on a quire in a memory to produce an operation result, converting the operation result into a posit or floating-point result, and returning the result to one of the cores.

### TECHNICAL FIELD

The present disclosure is directed, in general, to systems and methods for computation using QUIREs and, in particular, systems and methods for implementing QUIREs on systems with multiple cores.

### BACKGROUND OF THE DISCLOSURE

Posit arithmetic is a numerical system introduced by John L. Gustafson as an alternative to the traditional IEEE floating-point (FP) arithmetic. Posits aim to provide higher accuracy, efficiency, and dynamic range with fewer bits compared to floating-point numbers.

A posit number consists of four main components:
Sign Bit(s)—Determines whether the number is positive or negative.
Regime (r)—A variable-length field that encodes the scale of the number.
Exponent (e)—A fixed-length field that provides additional scaling (if available).
Fraction (f)/Mantissa—Represents the significant digits of the number.

Unlike IEEE floating points, posits dynamically allocate bits between these fields depending on the value, leading to better precision in small and large numbers. Posits allow higher precision in fewer bits for commonly used numbers. Posits allow for better range representation by adaptively distributing precision where it is needed. Posits do not require special cases that appear in floating-point such as “not a number” (NaNs), infinities, or signed zeros, and instead use a single special value for finite numbers that are too large to represent: ±maxpos (largest representable posit). Posit implementations require fewer logic gates compared to IEEE floating points.

A “quire” or “quire register” in posit arithmetic is a special data structure used in posit arithmetic for high-precision accumulation of a (potentially large) number of terms without rounding or loss of the contribution of small terms. In a hardware implementation, a quire is an extended accumulator register that allows storing exact intermediate results when performing multiple floating-point operations, especially matrix multiplications such as dot products. It prevents rounding errors and non-associativity that typically occur in floating-point arithmetic. These errors often lead to large errors in the final result. Also, when computing terms in parallel, floating point accumulated sums will have variable answers depending on the order in which the terms are added. With quires, the final answer is invariant with respect to the order of the additions.

The quire can be considered as an “unbounded precision accumulator,” similar to a super accumulator in floating-point arithmetic but optimized for posits. The Standard for Posit Arithmetic (2022) (the “Standard”) by the Posit Working Group, incorporated herein by reference, defines the storage formats and mathematical behavior of posit numbers, including basic arithmetic operations and the set of functions a posit system must support. The Standard describes posit and quire formats, including quire encoding in a register. Current research has assumed that a quire is implemented as a register within a single CPU core. This can lead to redundancy and inhibit parallel processing. Improved systems are desirable.

### SUMMARY OF THE DISCLOSURE

Various disclosed embodiments include a method for performing posit processes using a quire implemented by a memory controller. A method is performed by the memory controller and includes receiving one or more quire operation commands from at least one processing core, executing the quire operation commands on a quire in a memory to produce an operation result, converting the operation result into a posit or floating-point result by the memory controller, and returning the result to one of the at least one processing core by the memory controller.

In various embodiments, the method can include receiving an initialization command to initialize the quire in the memory and initializing the quire in the memory.

In various embodiments, the quire operation commands are received from multiple processing cores in communication with the memory controller. In various embodiments, executing the quire operation commands includes performing a conversion from a floating-point number or a posit number to a quire format. In various embodiments, executing the quire operation commands includes performing a conversion from floating-point numbers of different sizes or posit numbers of different sizes to a quire format of a predetermined size.

Disclosed embodiments also include a quire memory controller. The quire memory controller includes a memory controller unit in communication with a memory and a communications crossbar configured to receive requests from a plurality of processing cores and to transmit responses to the plurality of processing cores. The quire memory controller includes an issue/retry block in communication with the communications crossbar and a cache read stage in communication with the issue/retry block and an atomic cache. The quire memory controller includes an operation steering stage in communication with the cache read stage, the memory controller unit, and the atomic cache, and an adder pipeline in communication with the operation steering stage. The quire memory controller includes a cache/memory update stage in communication with the adder pipeline, the memory controller unit, and the atomic cache. The quire memory controller includes a response unit in communication with the cache/memory update stage and the communications crossbar. In various embodiments, the quire memory controller also includes a retry queue in communication with the operation steering stage and the issue/retry block. The quire memory controller can be configured to perform methods and processes as disclosed herein.

Various embodiments also include a computer system, which in some cases can be a system-on-a-chip or a plurality of interconnected systems-on-a-chip. The computer system can include a plurality of processing cores, an on-chip interconnect, and one or more quire memory controllers connected to communicate with the plurality of processing cores and to control an external memory. The quire memory controller implements at least one quire accessible by the plurality of processing cores and stored in the memory. The quire memory controller can be configured as described herein and can be configured to perform methods and processes as disclosed herein.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIGS. 1A and 1B illustrate an example of a proposal for implementing posit arithmetic in a computer system;

FIG. 2 illustrates a non-limiting example of a conventional system-on-a-chip design;

FIG. 3 illustrates a high-level view of elements of a system on a chip in accordance with disclosed embodiments;

FIG. 4 illustrates an example of a block diagram of a quire memory controller in accordance with disclosed embodiments;

FIG. 5 illustrates the minimum quire size for input format as used in some embodiments;

FIG. 6 illustrates a stage of an adder pipeline in accordance with disclosed embodiments; and

FIG. 7 illustrates a flowchart of an example process for performing posit processes in accordance with disclosed embodiments.

### DETAILED DESCRIPTION

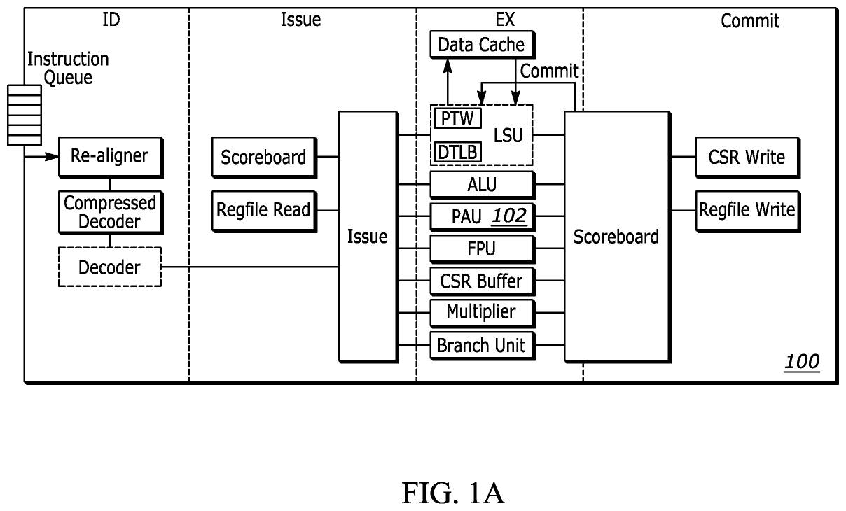

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include systems and methods for implementing quires in a memory controller, providing significant advantages over posit arithmetic architectures as currently studied. Disclosed embodiments can sum huge numbers (billions) of individual terms consisting of either individual values or products of pairs of values. The values may be represented as either IEEE-754 floating point numbers or posits without performing rounding and encountering a loss of accuracy due to rounding. In addition, the terms may be calculated concurrently and summed in arbitrary order, as additions in a quire are associative and idempotent. These properties avoid the need for the software comprising the concurrent threads to calculate the terms to be executed in any particular order, thus improving performance and greatly simplifying the design of that software.

FIGS. 1A and 1B illustrate an example of a proposal for implementing posit arithmetic in a computer system, as depicted in David Mallasén, et al., “Big-PERCIVAL: Exploring the Native Use of 64-Bit Posit Arithmetic in Scientific Computing,” IEEE Transactions on Computers, 2024, incorporated herein by reference.

FIG. 1A illustrates a block diagram of “Big-PERCIVAL,” a posit RISC-V core, based on the application-level CVA6 core, that supports either posit64 numbers or posit32 numbers and implements quire capabilities. This figure shows that the proposed “posit arithmetic unit” (PAU) 102 is integrated into the core 100 itself.

FIG. 1B illustrates the architecture, as proposed by Mallasén, et al., of the PAU 102 in the core 100. Note the quire 104, in the PAU 102, in the core 100.

As discussed above, the known approaches to posit arithmetic are limited to quires implemented as a register in a single core. Disclosed embodiments improve on these approaches by implementing the quire in a memory controller that is shared by a plurality of CPU cores but maintains the atomicity of quire operations.

Disclosed embodiments provide significant advantages over the implementations described in the standard and known in the art. For example, in accordance with disclosed embodiments, quires are specified as a variable type located at an arbitrary memory location. Multiple quires may be active simultaneously, allowing groups of cores to carry on computations without mutual interference. This provides a significant improvement over other quire implementations, in which each CPU core has a single quire that must be managed as a system resource, so that only one quire computation can occur in each core at a time and the quire must be saved and restored when switching contexts.

As another example, according to disclosed embodiments, computations may be performed concurrently in multiple CPU cores without any need to enforce ordering. Each core performs its piece(s) of the computation, such as a series of Multiply-Accumulate instructions that specify a quire as destination, and the results are summed in the specified quire. This is a significant improvement over other quire implementations, in which each core accumulates its results into its own quire. If multiple cores are engaged in a computation using other quire approaches, a barrier must be used to synchronize the cores, and a software routine must then be employed to combine the results of all of the quires used. This results in quire-in-a-core architectures having generally lower performance and greater complexity.

Quire-in-a-core architectures are also expensive in terms of logic used. If the core supports computation on N-bit numbers, a 16*N bit quire is required. For example, 64-bit computations require a 1024-bit quire. Thus, a 16*N-bit adder and a 16*N-bit register is needed. By implementing the quire in the memory controller, as disclosed herein, only one such implementation is needed rather than one in each CPU core.

Supporting the quire-in-a-core architecture generally requires numerous special instructions added to the core's instruction set to support both operations on the Quire and moving the quire's contents to and from data structures located in memory. When the quire is implemented in the memory controller as disclosed herein, however, its contents can be accessed using ordinary LOAD and STORE instructions, obviating the need for special data movement instructions.

Disclosed embodiments also improve on the implementations suggested in the Standard and the art by implementing support for accumulation of both IEEE-754 arithmetic and Posit arithmetic in the same quire, therefore increasing flexibility and simplifying porting of programs.

Disclosed embodiments can include a set of modifications to the CPU cores in a multicore System-On-Chip (SOC) implementation containing a plurality of cores, one or more intelligent memory controllers that are designed to support quires whose state is stored in the attached memory (a “quire memory controller”), and an on-chip fabric that connects the cores, the memory controllers, and other devices such as I/O controllers. Other than the changes required to support quires, the SOC design is standard and may be modified according to other system requirements.

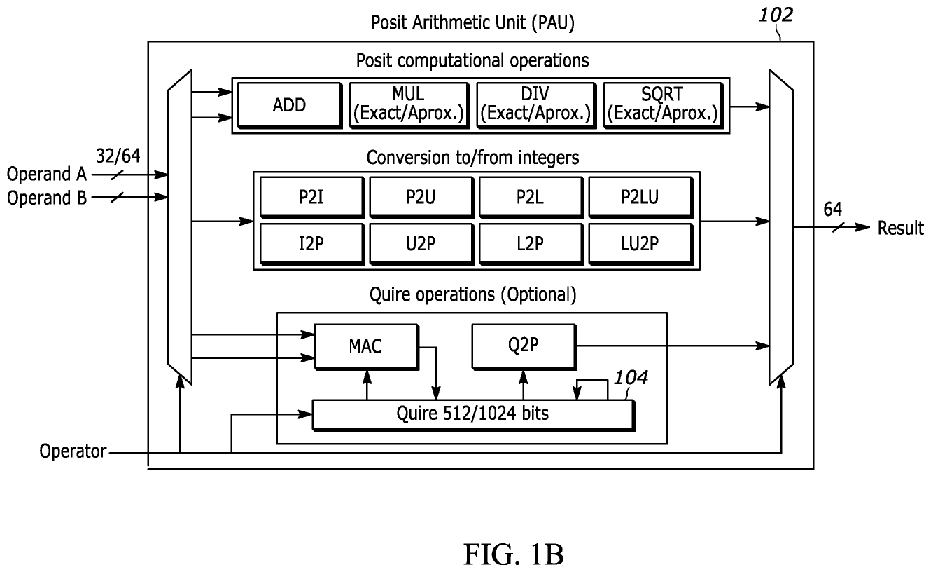

FIG. 2 illustrates a non-limiting example of a conventional SOC design. Note in particular the processor 202, which may contain multiple cores, which is in communication with memory controller 204. Other examples of SOC architectures can include more processors 202 and changes in other conventional elements, as known to those of skill in the art. Any of these can be used to implement the embodiments disclosed herein, when modified as described.

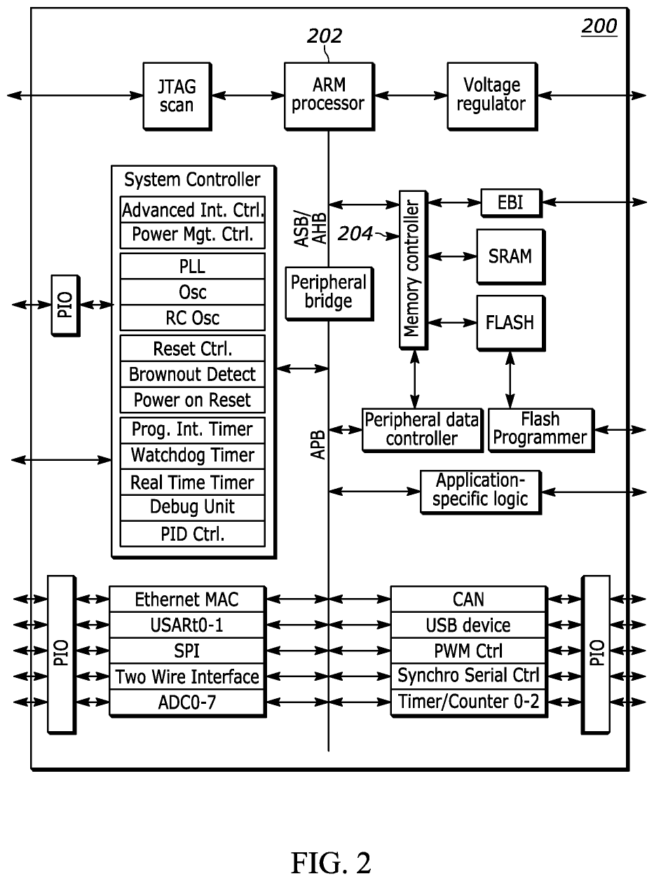

FIG. 3 illustrates a higher-level view of elements of a system on a chip 300 in accordance with disclosed embodiments. Systems used to implement disclosed embodiments, which may include a system on a chip 300, may be referred to herein as a “computer system.” As described above, this example shows a plurality of processing cores 302 (individually, 302a, 302b, . . . 302n) connected to an on-chip interconnect 304. Cores 302 communicate via on-chip interconnect 304 with quire memory controller 306, which itself communicates with external memory 308, which may be any known memory type. Here, “external” memory refers to memory separate from the cores, which can include memory implemented on a system-on-a-chip 300 or on another component altogether. External memory stores (among other data) one or more quires 301, under the control of quire memory controller 306. Other devices 310 can also communicate via on-chip interconnect 304 with quire memory controller 306, cores 302, and each other.

As may be understood from the discussion below, the quire memory controller 306 implements quires 310, which can be treated as typical quire accumulators, but these quire accumulator registers are actually data stored at specific quire addresses in memory 308. Quire memory control 306 can manage the reading and writing to these quire addresses in memory 308 so that the quire's accumulator registers are effectively “located” in quire memory controller 306.

The processing cores 302 can be implemented using conventional processors or controllers, modified to include several additional instructions that provide the ability to transmit values to quires allocated in memory by the application software. The added instructions may operate on either IEEE-754 numbers of any size defined by the standard, posits of any size defined by that standard, or a combination of these types. The definition of the instructions or instruction names may be varied for consistency with the Instruction Set Architecture (ISA) in use, or to meet other requirements.

For the discussion below, reg, reg1, and reg2 specify registers in a CPU core that contain operands in the chosen number format, and address, address1, address2, and address3 specify the starting address of quires in memory 308 controlled by quire memory controller 306.

Various embodiments include supporting the operations of the instructions below, though the actual instruction names and parameters may differ in various implementations.

ADD-TO-QUIRE (reg, address) A value in reg is transmitted to the quire 310 at location address in memory 308, where the quire memory controller 306 adds the value to the quire 310.

MULADD-TO-QUIRE (reg1, reg2, address) Values in reg1 and reg2 are multiplied together and the product is transmitted to the quire 310 at location address in memory 308, where the quire memory controller 306 adds the product to the quire 310. The product contains twice as many fraction bits as the values in the registers, and no rounding occurs before transmitting the product. The product also contains one more exponent bit than the values in the registers. This expanded product thus contains all bits that can be mathematically generated by multiplication, so no information is lost when the value is added to the quire.

Disclosed embodiments also include processes to perform certain other operations on quires in memory. Since quires 308 are also accessible using regular memory operations such as LOAD and STORE, it is possible to perform methods on quires using software functions. As these methods are generally not critical to performance, implementation in software should generally be acceptable. Alternatively, hardware instructions may be provided to simplify the software or to make incremental performance improvements:

Quire-To-Float (reg, address)/Quire-To-Posit (reg, address) The value in the quire 310 specified by address is converted to a Float or Posit and the result is stored in reg.

Add-Quires (address1, address2, address3) The quires 310 specified by address1 and address2 are added and the result is stored at address3.

SUB-From-QUIRE (reg, address) A value in reg is transmitted to the quire 310 at location address in memory 308, where the quire memory controller 306 subtracts the value from the quire 310.

MULSUB-TO-QUIRE (reg1, reg2, address) Values in reg1 and reg2 are multiplied together and the product is transmitted to the quire 310 at location address in memory 308, where the quire memory controller 306 subtracts the product from the quire 310. The product contains twice as many fraction bits as the values in the registers, and one more exponent bit than the values in the registers, and no rounding occurs before transmitting the product.

Zero-QUIRE (address) The quire 310 at location address in memory 308 is set to zero.

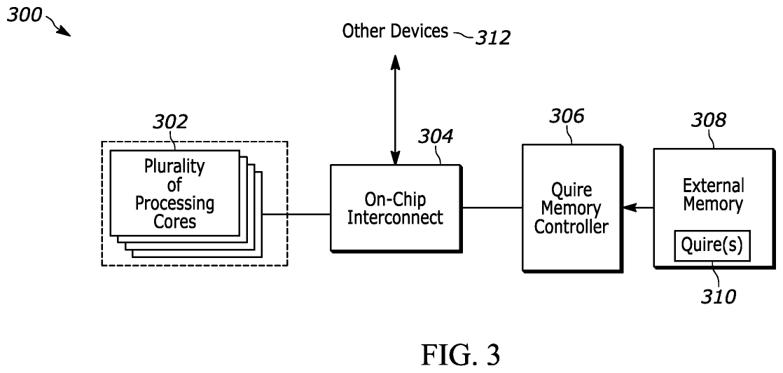

FIG. 4 illustrates a non-limiting example of a block diagram of a quire memory controller 306 in accordance with disclosed embodiments. In this example, the quire memory controller 306 includes a memory controller unit 402 connected to communicate with one or more memory modules 404 (such as external memory 308).

The quire memory controller 306 can act exactly like an ordinary memory controller except when performing quire operations. Thus, it supports READ and WRITE operations as expected in a memory controller in an SOC. Additionally, quire memory controller 306 performs the actions necessary to implement the functions previously described. Optionally, it may also support additional Read-Modify-Write functions that may be required in the system but are not part of this invention.

According to various embodiments, the system as a whole, such as SOC architecture 300, is configured as a plurality of CPU cores sharing a single memory system that incorporates one or more quire memory controllers 306 (shown singularly in this example). Requests come to the memory system via the request crossbar 406A (part of the on-chip fabric/interconnect 304), and responses, which include both data responses to Read commands and Acknowledges (ACKs) to Write and Read-Modify-Write commands, are returned to the requesting core on the response crossbar 406B (part of the on-chip fabric/interconnect 304). Request crossbar 406A and response crossbar 406B can be implemented together as a general communications channel (together, communications crossbar 406) implemented by on-chip fabric/interconnect 304. Communications crossbar 406 is configured to receive requests from a plurality of processing cores and to transmit responses to the plurality of processing cores

Incoming requests enter the memory system (that is, quire memory controller 306 in combination with memory 308/memory module 404) at the issue/retry block 408. Issue/retry block 408 arbitrates and multiplexes among new inputs and inputs being retried internally, which enter from the retry queue 420.

The atomic cache 422 is used to maintain state for quire operations and other Read-Modify-Write operations that may be implemented in the quire memory controller 306. Atomic cache 422 can be implemented, for example, as a copy-back cache whose line size is at least as large as the size of the largest quire that will be supported, and other cache strategies, such as write-thru, can also be implemented. In various embodiments, the “virtual” quire, as physically implemented at an address in memory module 404, is resident in the atomic cache 422 before proceeding with the operation. If a quire operation is requested and the operation misses in the atomic cache 422, the request is sent to the retry queue 420 while the atomic cache 422 is being filled. It may pass through the retry queue 420 multiple times until a hit occurs in atomic cache 422.

Control of the atomic cache 422 is distributed among the cache read stage 410, operation steering stage 412, and cache/memory update stage 416 of the pipeline illustrated above.

The multiplexed requests enter the cache read stage 410. In this stage the cache and its tags are accessed, and the request plus the cache contents accessed are forwarded to the operation steering stage 412.

The operation steering stage 412 is responsible for determining the nature of the requested operation and the actions required to execute the request. In general, if the requested operation is a READ, it will be satisfied from the atomic cache 422 if it hits. If there is a miss at atomic cache 422, quire memory controller 306 will bypass the atomic cache 422 and be satisfied from memory 404. Cache lines do not need to be allocated by READs, although in various embodiments a different policy may be adopted without departing from the scope of this disclosure.

If the requested operation is a write, operation steering stage 412 can update the atomic cache 422 on a hit, and update memory 404 on a miss. If a READ, a WRITE, or a new RMW hit on an address that already has a RMW operation (including quire operations and other RMW operations that the system chooses to support) in progress, the READ or WRITE can be sent into the retry queue 420 until the previous RMW operation has finished.

All requests that do not need to be retried are forwarded into the adder pipeline 414. If the operation is a READ or a WRITE, the operation passes through the adder pipeline 414 without action.

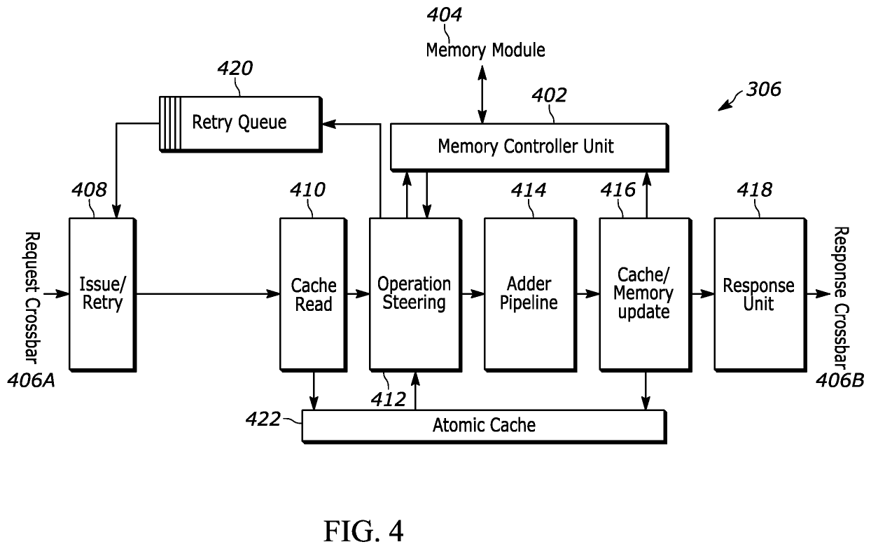

If the operation is an Add-to-Quire operation, it is converted from its input format (sign plus exponent plus fraction as separate fields) to quire format, which is a twos complement integer that has the width of the quire, as described below. This can be accomplished by shifting the incoming fraction field left the number of places specified by the exponent field, as illustrated in FIG. 5, below. This value is added to the quire using a full-width adder. It is expected that this adder pipeline 414 can be implemented using multiple pipe stages and can be implemented using any combination of carry lookahead, carry save, and carry select techniques.

Operation responses are returned from quire memory controller 306 by response unit 418.

FIG. 5 illustrates the minimum quire size for input format as used in some embodiments. This table shows, for each number format in either posit format (P) or floating-point format (F) for a given number of bits, the minimum quire width, fraction width, and exponent width used by quire memory controller 306.

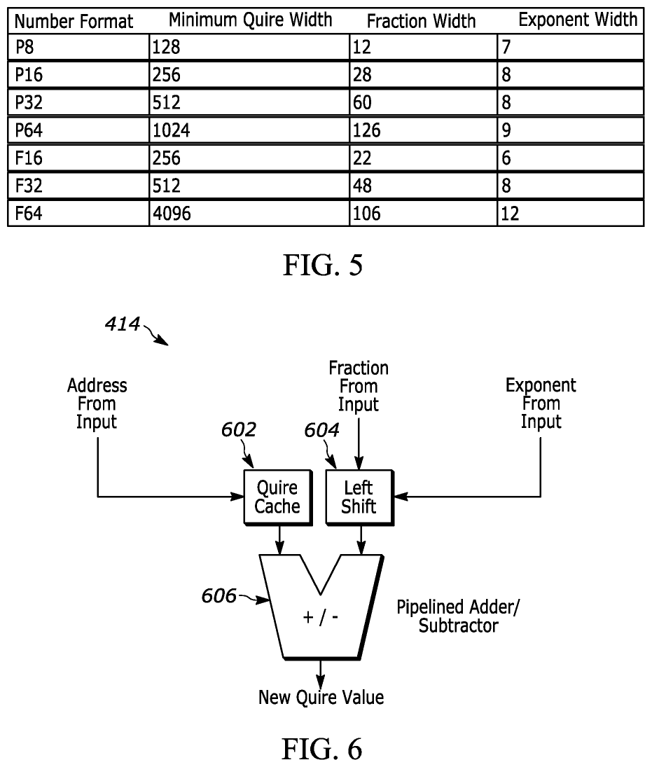

FIG. 6 illustrates a stage of an adder pipeline 414 in accordance with disclosed embodiments, including quire cache 602, left shift unit 604, and pipelined adder/subtracter 606.

When the adder pipeline 414 operation is complete, its result enters the cache/memory update stage 416. In this stage, the value in the atomic cache 422 is updated and the atomic cache 422 is marked Dirty for operations (including Quires, WRITES that hit in cache, and other RMW operations) that modify memory 404 and are cached. Operations that modify memory 404 and are not in the atomic cache 422 (WRITEs) send updates to memory 404 and do not change the atomic cache 422. READ operations pass through this cache/memory update stage 416 without updating the memory 404 or the atomic cache 422. The operation is then passed on to the response unit 418.

The response unit 418 is responsible for completing the operation by sending a response back to the requestor through the on-chip fabric 406. READS, and some Read-Modify-Write operations can send a data word as a response back to the requesting core. Quire operations, WRITEs, and all other Read-Modify-Write operations complete by sending an Acknowledge message back to the requestor.

If an error occurred in processing any request, information concerning the error is included in the response that is sent.

Upon sending a response, the quire memory controller 306 no longer needs to retain any state concerning the completed operation.

In various embodiments, the protocol that provides communication between the processing cores 302 and the quire memory controller 306 can include a new transaction type in addition to the standard transactions used between these units in current systems. This transaction is an Add-To-Quire command, as below:

| | | | | |
|---|---|---|---|---|
| Command | Size | Mem Address | Exponent | Fraction |

The Add-To-Quire command carries an operation code that specifies the operation and the size of the supplied operand. The Add-To-Quire command also carries an address and two data elements: an exponent (or offset/shift amount) and a fraction. The fraction is preferably twice as wide as the fractional part of the posit or floating-point numbers that are input to multiply operations in the core, so that no bits of precision are lost when the product is added to the quire. The exponent/offset/shift amount is used to determine which of the quire's bits is the starting point (low order bit) of the summation that the memory controller will perform.

When the quire memory controller 306 receives an Add-to-Quire transaction, the quire memory controller 306 prepends a “hidden bit” to the fraction, and shifts the fraction left within a bit field of the same width as the quire, using the exponent as a shift amount. Quire memory controller 306 then adds the shifted value to the current value of the quire and stores the result back into the quire. This addition is preferably idempotent; that is, no other operation may access or modify the quire from the start of the operation until it has been completed.

In specific embodiments, the shift is performed in the quire memory controller 306. In other implementations the shift operation can be performed in the processing core instead of the quire memory controller 306. If done in the core, the fraction bits would be sent already shifted, and the exponent bits can be reduced to those not used in the shift operation.

Disclosed embodiments include a computer system (such as, but not limited to, a system-on-a-chip system 300) that contains a set of software components that provide application programs with a complete environment for computations with posits (or floats) and quires. Various embodiments can utilize specialized software components or processes, and other embodiments may use configured hardware components to perform similar processes. Software and hardware implementations of the processes disclosed herein are within the abilities of one of ordinary skill in the art.

Disclosed embodiments can implement various functions in order to comply with the Standard, but such functions are adapted to act on quires in memory as opposed to quires in CPU registers as assumed by the Standard. Such functions include:
posit function QuireToPosit (QuirePointer, PositWidth): A function that converts the value in a memory-based quire at location quire_pointer to a posit of width PositWidth. The usual expectation is that quires will receive addition requests hundreds to millions of times more often than their contents will be converted to posits. This usually makes it more practical to implement the conversion as a software function, but it is feasible to implement this operation in hardware if the conversion operation is frequent in a particular application.
void function AddQuires (QuirePointer1, QuirePointer2, QuirePointer3, PositWidth): This function adds two quires of width 16*PositWidth identified by QuirePointer1 and QuirePointer2, placing the sum in the quire identified by QuirePointer3.
void function ClearQuire (QuirePointer, PositWidth): This function clears the quire identified by QuirePointer.

Other functions may be added as needed by the target application. If the application uses IEE-754 floats instead of posits, the QuireToPosit function can be replaced or supplemented with a QuireToFloat function.

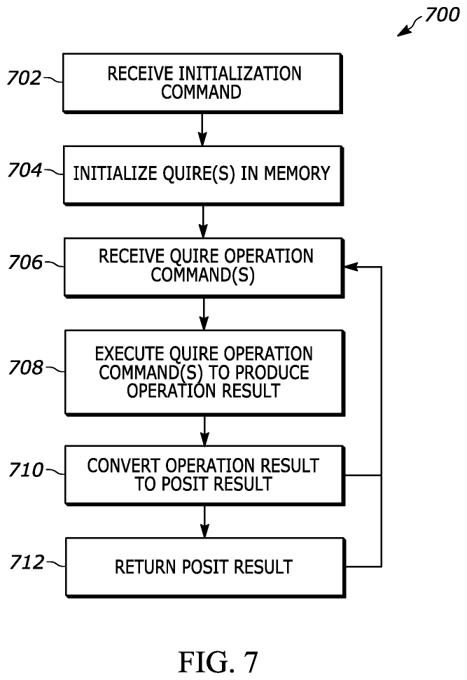

FIG. 7 illustrates a flowchart of an example process 700 for performing posit processes using a quire as disclosed herein, in accordance disclosed embodiments. Such a process can be performed, for example, by a quire memory controller 306 as disclosed herein, such as on a system-on-a-chip 300 as disclosed herein or on another computer system architecture.

At 702, the memory controller receives an initialization command to initialize one or more quires. This can include, for example, receiving a command such as QuirePointer=malloc (16*PositWidth) to create each quire. This can also include, for example, receiving a command such as ClearQuire (QuirePointer, PositWidth) to initialize each quire to zero.

At 704, the memory controller initializes one or more quires in a memory, in accordance with the received command(s).

At 706, the memory controller receives one or more quire operation commands. As the application or process is executing on the system, it will perform computations, potentially parallelized across multiple processing cores, and send quire operation commands to the memory controller.

For example, the application may perform, and the memory controller receive, ADD-TO-QUIRE and/or MULLADD-TO-QUIRE commands to accumulate a result in a quire without rounding or loss of tiny values in the accumulation. The result computed will always be the same regardless of the order of the accumulation operations, and it is unnecessary to implement software that enforces an order on the accumulation steps.

At 708, the memory controller executes the quire operation commands on the initialized quire(s) in memory, such that the memory-based quire(s) act as accumulator register quires, to produce an operation result. Multiple memory-based quires may be used if so many compute cores are in use that quire bandwidth becomes a limitation.

If multiple quires are in use, the memory controller can sum them using a command such as AddQuires (QuirePointer1, QuirePointer2, QuirePointer3, PositWidth).

At 710, the memory controller converts the operation result into a posit result. Here, the operation result can be converted to a posit using a command such as QuireToPosit (QuirePointer, PositWidth). This result is properly rounded and is fully reproducible regardless of the order of computation or the number of parallel threads employed in the computation. In other cases, the memory controller can convert the result to an IEEE-754 floating-point result using a similar command if the system is processing floating-point numbers. By loading a number in one format into a quire then returning it in another format, executing quire operation commands can effectively perform a conversion between a floating-point number and a posit number (and vice-versa). Similarly, since the size of the output can be defined by QuireToPosit or a corresponding command for floating-point numbers, executing the quire operation commands can include performing a conversion between floating-point numbers of different sizes or posit numbers of different sizes.

At 712, the memory controller returns the posit result to the system. This can be an active process performed when the posit result has been produced, and this can be performed in response to receiving a read request for the contents of the quire(s).

In various use cases, at either 710 or 712, the memory controller process may return to 706 to receive additional quire operation commands for ongoing calculations. Initialization steps 702 and 704 need not be repeated for each iteration.

Various embodiments include a compiler that supports quire data types as discussed herein so that quires can be declared in high-level languages. Such a compiler can also include support for the IEEE-754 and/or posit data types used in the system, and support for generating the added instructions discussed above that support quires.

Various embodiments can perform any number of functions using a quire accessible my multiple processing cores. For example, various embodiments can perform addition or subtraction of products of pairs of posits or floats to a quire without loss of accuracy or introducing dependencies on order of the additions. Various embodiments can perform addition or subtraction of single of posits or floats to a quire without loss of accuracy or introducing dependencies on order of the additions. Various embodiments can perform conversion of a value in a quire to a posit or floating-point number. Various embodiments can perform addition or subtraction of two quires to a third quire. Various embodiments can perform other arithmetic operations on quires as may be required by a particular application or system.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all systems suitable for use with the present disclosure is not being depicted or described herein. Instead, only so much of a computer system as is unique to the present disclosure or necessary for an understanding of the present disclosure is depicted and described. The remainder of the construction and operation of the systems and components described herein may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves, and is not intended to invoke 35 U.S.C. § 112(f).

1. A method for performing posit processes using a quire implemented by a memory controller, the method performed by the memory controller and comprising:
receiving, by a memory controller, one or more quire operation commands from at least one processing core;
executing the quire operation commands, by the memory controller, on a quire in a memory to produce an operation result;
converting the operation result into a posit or floating-point result by the memory controller; and
returning the result to one of the at least one processing core by the memory controller.

2. The method of claim 1, wherein the quire operation commands are received from multiple processing cores in communication with the memory controller.

3. The method of claim 1, further comprising:
receiving, by the memory controller, an initialization command to initialize the quire in the memory; and
initializing, by the memory controller, the quire in the memory.

4. The method of claim 1, wherein executing the quire operation commands includes performing a conversion from a floating-point number or a posit number to a quire format.

5. The method of claim 1, wherein executing the quire operation commands includes performing a conversion from floating-point numbers of different sizes or posit numbers of different sizes to a quire format of a predetermined size.

6. A quire memory controller comprising:
a memory controller unit in communication with a memory;
a communications crossbar configured to receive requests from a plurality of processing cores and to transmit responses to the plurality of processing cores;
an issue/retry block in communication with the communications crossbar;
a cache read stage in communication with the issue/retry block and an atomic cache;
an operation steering stage in communication with the cache read stage, the memory controller unit, and the atomic cache;
an adder pipeline in communication with the operation steering stage;
a cache/memory update stage in communication with the adder pipeline, the memory controller unit, and the atomic cache; and
a response unit in communication with the cache/memory update stage and the communications crossbar.

7. The quire memory controller of claim 6, further comprising a retry queue in communication with the operation steering stage and the issue/retry block.

8. The quire memory controller of claim 6, configured to:
receive one or more quire operation commands from at least one of the plurality of processing cores;
execute the quire operation commands on a quire in the memory to produce an operation result;
convert the operation result into a posit or floating-point result; and
return the result to at least one of the plurality of processing cores.

9. The quire memory controller of claim 8, wherein the quire operation commands are received from multiple processing cores in communication with the memory controller.

10. The quire memory controller of claim 8, wherein the quire memory controller is further configured to:
receive an initialization command to initialize the quire in the memory; and
initialize the quire in the memory.

11. The quire memory controller of claim 8, wherein executing the quire operation commands includes performing a conversion from a floating-point number or a posit number to a quire format.

12. The quire memory controller of claim 8, wherein executing the quire operation commands includes performing a conversion from floating-point numbers of different sizes or posit numbers of different sizes to a quire format of a predetermined size.

13. A computer system, comprising:
a plurality of processing cores;
an on-chip interconnect; and
a quire memory controller connected to communicate with the plurality of processing cores and to control an external memory, wherein the quire memory controller implements at least one quire accessible by the plurality of processing cores and stored in the memory.

14. The computer system of claim 13, wherein the computer system is configured to:
receive one or more quire operation commands by the quire memory controller from at least one of the plurality of processing cores;
execute the quire operation commands on the at least one quire to produce an operation result;
convert the operation result into a posit or floating-point result; and
return the result to at least one of the plurality of processing cores.

15. The computer system of claim 14, wherein the quire operation commands are received from multiple processing cores in communication with the memory controller.

16. The computer system of claim 14, wherein the computer system is further configured to:
receive, by the quire memory controller, an initialization command to initialize the quire in the memory; and
initialize, by the quire memory controller, the quire in the memory.

17. The computer system of claim 14, wherein executing the quire operation commands includes performing a conversion from a floating-point number or a posit number to a quire format.

18. The computer system of claim 14, wherein executing the quire operation commands includes performing a conversion from floating-point numbers of different sizes or posit numbers of different sizes to a quire format of a predetermined size.

19. The computer system of claim 13, wherein the quire memory controller comprises:
a memory controller unit in communication with the memory;
a communications crossbar, implemented by the on-chip interconnect, configured to receive requests from the plurality of processing cores and to transmit responses to the plurality of processing cores;
an issue/retry block in communication with the communications crossbar;
a cache read stage in communication with the issue/retry block and an atomic cache;
an operation steering stage in communication with the cache read stage, the memory controller unit, and the atomic cache;
an adder pipeline in communication with the operation steering stage;
a cache/memory update stage in communication with the adder pipeline, the memory controller unit, and the atomic cache; and
a response unit in communication with the cache/memory update stage and the communications crossbar.

20. A quire memory controller comprising:
a memory controller unit in communication with a memory;
a communications crossbar configured to receive requests from a plurality of processing cores and to transmit responses to the plurality of processing cores;
an issue/retry block in communication with the communications crossbar;
a cache read stage in communication with the issue/retry block and an atomic cache;
an operation steering stage in communication with the cache read stage, the memory controller unit, and the atomic cache;
an adder pipeline in communication with the operation steering stage;
a cache/memory update stage in communication with the adder pipeline, the memory controller unit, and the atomic cache;
a response unit in communication with the cache/memory update stage and the communications crossbar; and
a retry queue in communication with the operation steering stage and the issue/retry block,
wherein the quire memory controller is configured to implement at least one quire stored at an address in the memory and accessible by the plurality of processing cores, and wherein the adder pipeline is configured to convert a received value from a posit or floating-point format to a quire format and to add the converted value to the quire.
